(19) United States
(12) Patent Application Publication
(10) Pub. No.: US 2002/0006767 A1
(43) Pub. Date: Jan. 17, 2002

(54) Ion exchange pad or brush and method of regenerating the same

(75) Inventors: Yuchun Wang, San Jose, CA (US); Rajeev Bajaj, Fremont, CA (US); Fred C. Redeker, Fremont, CA (US)

Correspondence Address: PATENT COUNSEL, APPLIED MATERIALS, INC., Legal Affairs Department, P.O.BOX 450A, Santa Clara, CA, 95052, US

(73) Assignee: Applied Materials, Inc.

(21) Appl. No.: 09/843,582

(22) Filed: Apr. 26, 2001

Related U.S. Application Data
(63) Continuation-in-part of application No. 09/737,414, filed on Dec. 14, 2000.
(60) Provisional application No. 60/171,492, filed on Dec. 22, 1999.
(60) Provisional application No. 60/213,097, filed on Jun. 21, 2000.

(51) Int. Cl. B08B 1/04; B08B 6/00; B24B 7/00

(52) U.S. Cl. 451/41; 15/77; 15/88.3; 15/102; 134/2; 134/3; 134/6

(57) ABSTRACT

An inventive brush, pad or the like is provided that has functional groups (complexing agents) such as chelating reagents. The complexing agents may be chemically grafted to the brush or pad, may be resin beads physically blended with the brush materials, or the brush or pad may be made of a homogeneous material containing a complexing polymer. The immobilized complexing agents on the brush can effectively pick up metal ions or metal oxides from the substrate surface upon contact but may not etch into the metal lines.

### CROSS-REFERENCE TO RELATED APPLICATIONS

This is a continuation-in-part of co-pending prior U.S. non-provisional patent application serial no. 09/737,414, (AMAT No. 4260) filed Dec. 14, 2000 entitled “Ion Exchange Materials for Chemical Mechanical Polishing”, which claims the benefit of U.S. provisional patent application Ser. No. 60/171,492, filed Dec. 22, 1999; this application also claims the benefit of U.S. provisional patent application Ser. No. 60/213,097, (AMAT No. 4673/L) filed Jun. 21, 2000. The entire contents of the Ser. No. 09/737,414 non-provisional patent application and the two provisional patent applications are incorporated herein by reference.

### FIELD OF THE INVENTION

This invention is concerned with semiconductor device manufacturing and is more particularly concerned with chemical mechanical polishing of semiconductor substrates.

### BACKGROUND OF THE INVENTION

After chemical mechanical polishing (CMP) of metals for manufacturing integrated circuits, substrate cleaning is critical to remove metallic contamination such as copper from both the front side and back side of the substrate. PVA (polyvinyl alcohol) brushes are currently used to scrub the substrate in concert with diluted etching solution such as Applied Materials' ElectraClean™ solution. As the interconnect copper lines get smaller and smaller, minimum metal loss via contact with the etching chemical is desired. In addition, the etching residue generated at one location may redeposit on other locations if the residue is not immediately rinsed off. Accordingly, improved methods and apparatuses are needed for removing metal from a substrate during substrate polishing (e.g., CMP) and/or during substrate cleaning (e.g., scrubbing).

### SUMMARY OF THE INVENTION

An inventive brush, pad or the like with functional groups (hereinafter referred to as complexing agents) such as (but not limited to) chelating reagents is provided. The complexing agents may be chemically grafted on the brush or pad, may be resin beads physically blended with the brush materials, or the brush or pad may be made of a homogeneous complexing polymer. One aspect is to graft an amine chelating reagent on a PVA brush. The immobilized complexing agents (i.e., solid phase complexing agents) on the brush can effectively pick up metal ions (e.g., copper ions) or metal oxides (e.g., copper oxide) from the substrate surface upon contact but may not etch into the metal lines. For example, the chelating reagents may bond with copper ions with sufficient strength to avoid the reloading of copper onto the substrate surface. Use of the functionalized brushes may simplify cleaning and/or polishing solution handling and may reduce cleaning and/or polishing waste generation. The inventive brushes or pads may be made for a single use or they may be re-generated by washing with other chemicals.

Other features and advantages of the present invention will become more fully apparent from the following detailed description, the appended claims and the accompanying drawings.

### BRIEF DESCRIPTION OF THE DRAWINGS

FIG. 1 shows the structure of DowEX M4195;

FIG. 2 is a cross-sectional view illustrating the contact between metal particles from an upper surface of a substrate and an inventive scrubber brush;

FIG. 3 is a cross-sectional view illustrating the contact between an upper surface of a substrate and an inventive polishing pad;

FIG. 4A is a flowchart useful in describing a first inventive method that may regenerate the inventive scrubber brush or polishing pad by applying a regenerative complexing agent after the complexing agents of the inventive scrubber brush or polishing pad have bonded to metal particles or to a metal layer that is being polished;

FIG. 4B is a flowchart useful in describing a second inventive method that may regenerate the inventive scrubber brush or polishing pad by using a strong acid to provide hydrogen ions that replace metal ions bonded to the inventive scrubber brush or polishing pad;

FIG. 5 is a side schematic view of an exemplary scrubber;

FIG. 6 is a side schematic view of an exemplary polisher; and

FIG. 7 is a perspective view of a polishing apparatus that employs electrochemical regeneration to regenerate a polishing pad.

### DETAILED DESCRIPTION

The present invention provides a scrubber brush, a polishing pad or the like, having a reactive surface adapted to contact a substrate and to remove a metal therefrom. Specifically the reactive surface may comprise a complexing agent such as a chelating reagent, an ion exchange group or other functional group with which metal particles (e.g., metal ions, metal oxides, metal nitrides, other metal compounds, etc.) react (e.g., amines, carboxilates, chlorides, sulfonates, etc.). The complexing agent may be grafted onto conventional polymer scrubber brushes and polishing pads, particularly those comprising long polymer chains. In one aspect, the scrubber brushes and polishing pads are comprised either of a porous polystyrene or a porous polyethylene, which is saturated in an amine solution so as to form a homogeneous scrubber pad or polishing pad containing an amine throughout.

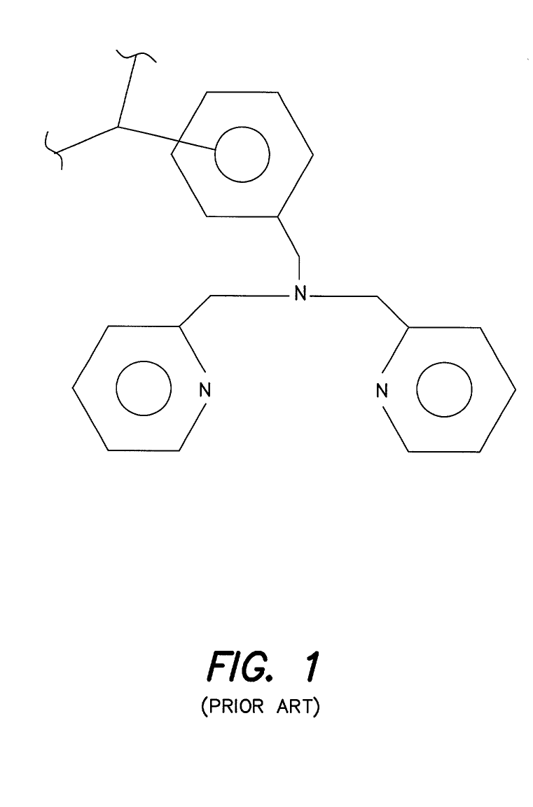

The complexing agent may be in the form of beads, foam or a film, etc. Examples of commercially available complexing agents include DowEX M4195 (reactive beads) sold by Dow Chemical, and aliphatic polyamines. The structure of the DowEX M4195 is shown in FIG. 1. The DowEX M4195 is comprised of a bispicolylamine functionality. The inventive scrubber brushes and polishing pads remove metal only from areas of the substrate that are contacted by the reactive surface. Thus, the inventive brushes and pads provide anisotropic metal removal, and may avoid problems experienced by conventional fluid etchants that flow along substrate surfaces and thus provide less controllable metal removal.

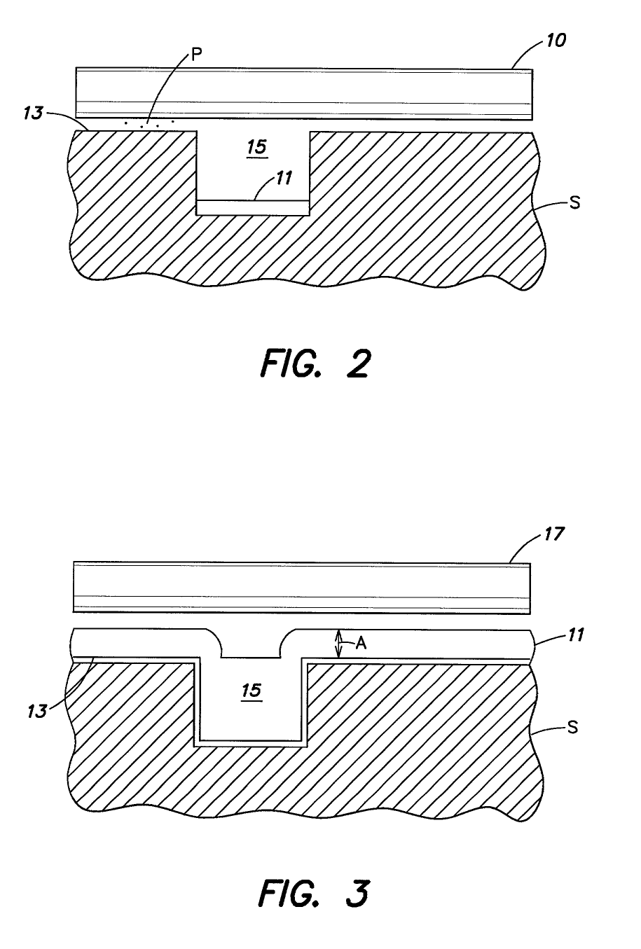

As depicted in FIG. 2, when scrubbing a substrate S with the inventive scrubber brush 10, metal particles P may be removed from an upper surface 13 of the substrate S, without removal of a metal layer 11 from a lower surface of the substrate S (e.g., from the bottom surface of a via 15) provided the inventive scrubber brush 10 is configured so as to contact only the upper surface 13. Because the chemical agent which removes the particles is a solid material attached (e.g., bonded, grafted, blended, etc.) to the scrubber brush 10, metal particles are only removed from surfaces that are contacted by the scrubber brush 10. Further, the metal particles P may be removed without the application of fluid chemistry (surfactants, etchants, etc.). Accordingly effective scrubbing can be achieved when the inventive scrubber brush 10 is used alone (e.g., without an etching fluid) and when the inventive scrubber brush 10 is used merely with deionized water.

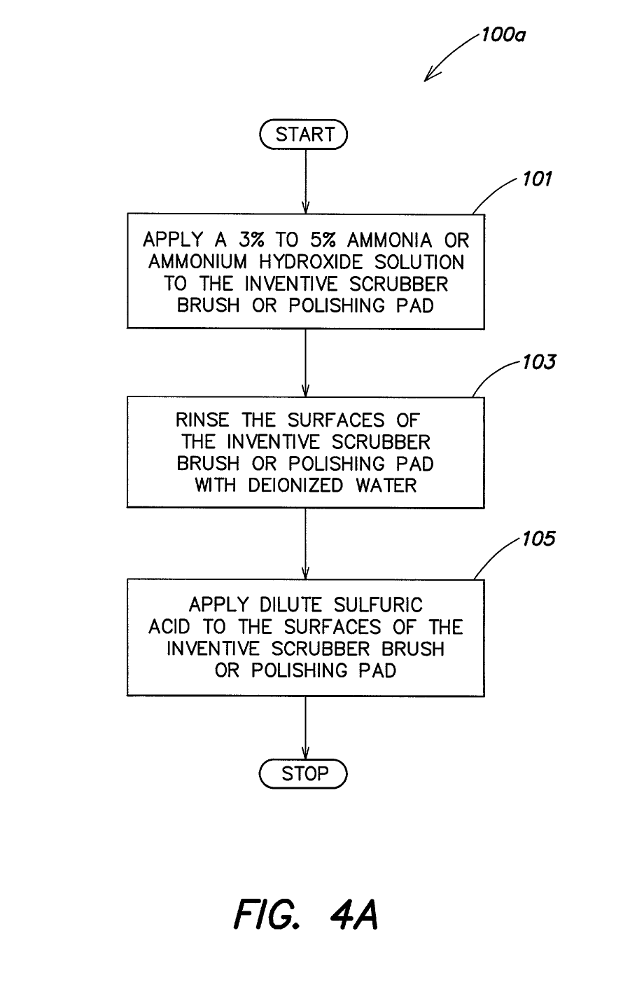

As depicted in FIG. 3, when polishing a semiconductor substrate S having a metal layer 11 formed over one or more vias 15, the inventive polishing pad 17 should comprise a sufficient amount of the complexing agent to complex the entire portion of the metal layer to be removed (e.g. the portion of the metal layer 11 formed on the upper surface 13 as indicated by arrow A). Conventionally, such metal layers have a thickness in the range of 1.1 microns to 1.5 microns, although other thicknesses may also be removed by the inventive polishing pad 17. The polishing achieved with the inventive polishing pad 17 may be more controllable and more repeatable than that experienced with the use of conventional polishing pads and slurries. More specifically, when polishing with a separate polishing pad and polishing agent (e.g. a slurry or fluid polishing chemical) both the polishing pad and the polishing chemical present a process variable. Because the inventive polishing pad 17 includes the chemistry needed for metal removal, the inventive polishing pad 17 may present only a single process variable and a high degree of etch uniformity (e.g., as the etch chemistry is not a liquid etch chemistry that may flow along substrate surfaces and thus provide less controllable metal removal). Further, the inventive polishing pad may allow a polishing apparatus and/or the program which controls the operation of the polishing apparatus to be simplified, because polishing chemistry need not be delivered to the polishing pad during polishing.

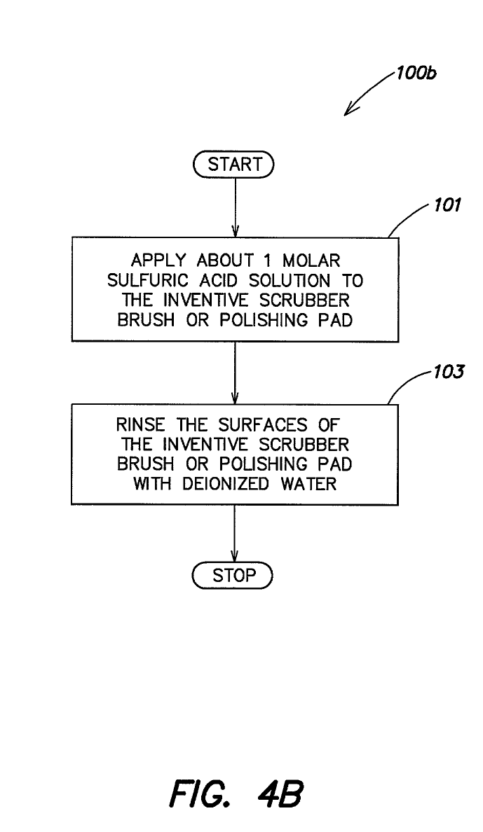

In order to reuse the inventive scrubber brush or polishing pad after the complexing agents of the inventive scrubber brush or polishing pad have bonded to the metal particles or to the metal layer being removed, the inventive scrubber brush or polishing pad may be regenerated via application of a complexing agent that is stronger than the complexing agent adhered to the reactive surface of the inventive scrubber brush or polishing pad. The complexing agent used to regenerate the inventive scrubber brush or polishing pad may comprise for example ammonia (NH₃), ammonium hydroxide (NH₄OH), or carboxylic acid. In one aspect, the ammonia or ammonium hydroxide may have a concentration of 3% to 5% by volume. Accordingly, the metal particles will become bonded to the regenerative complexing agent, and the complexing agent on the reactive surface of the inventive scrubber brush or polishing pad will again be able to adhere to metal particles found on the surface of the next substrate being scrubbed or polished. A strong acid such as sulfuric acid also may be used to regenerate the inventive scrubber brush or polishing pad via the replacement of metal ions bonded to the scrubber brush or polishing pad with hydrogen ions from the acid (as described below with reference to FIG. 4B).

FIG. 4A is a flowchart useful in describing a first inventive method 100a that may regenerate the inventive scrubber brush or polishing pad by applying a regenerative complexing agent after the complexing agents of the inventive scrubber brush or polishing pad have bonded to the metal particles or to the metal layer being removed. The inventive method 100a may be performed either while the inventive scrubber brush or polishing pad are scrubbing or polishing the substrate (i.e., in-situ regeneration), or after the inventive scrubber brush or polishing pad has scrubbed or polished the substrate (i.e., ex-situ regeneration). In step 101, a 3% to 5% ammonia or ammonium hydroxide solution is applied to the inventive scrubber brush or polishing pad, which has the metal particles adhered thereto. The ammonia or ammonium hydroxide solution should complex the metal particles adhered to the inventive scrubber brush or polishing pad because the ammonia or ammonium hydroxide solution has stronger complexing properties than the chelating agent originally used to form the inventive scrubber brush or polishing pad.

In step 103, the surfaces of the inventive scrubber brush or polishing pad are rinsed with deionized water to remove the ammonia or ammonium hydroxide solution therefrom. In step 105, dilute sulfuric acid (e.g., 0.1 wt % sulfuric acid, 99.9 wt % DI water) is applied to the surfaces of the inventive scrubber brush or polishing pad to increase the kinetics of the inventive method 100a.

During in-situ regeneration, the ammonia or ammonium hydroxide solution may be used both to regenerate the inventive scrubber brush or polishing pad, and to polish the surfaces of the substrate by complexing metal particles therefrom. When 2-3 Kilo-angstrom of metal particles remain on the inventive scrubber brush or polishing pad, the application of the ammonia or ammonium hydroxide solution may stop. Then, the chelating agent originally used to form the inventive scrubber brush or polishing pad may complex the remaining metal particles from the surfaces of the substrate. This may ensure that minimum dishing is achieved by using the rigid ion exchange resin pad only.

FIG. 4B is a flowchart useful in describing a second inventive method 100b that may regenerate the inventive scrubber brush or polishing pad by using a strong acid to provide hydrogen ions that replace metal ions bonded to the inventive scrubber brush or polishing pad. The inventive method 100b may be performed either while the inventive scrubber brush or polishing pad are scrubbing or polishing the substrate (i.e., in-situ regeneration), or after the inventive scrubber brush or polishing pad has scrubbed or polished the substrate (i.e., ex-situ regeneration). In step 101, an approximately 1 molar sulfuric acid solution is applied to the inventive scrubber brush or polishing pad, which has the metal particles adhered thereto. The sulfuric acid solution should provide sufficient hydrogen ions to replace metal ions adhered to the inventive scrubber brush or polishing pad.

In step 103, the surfaces of the inventive scrubber brush or polishing pad are rinsed with deionized water to remove the sulfuric acid solution therefrom.

Although the inventive scrubber brush and polishing pad may be employed within any scrubbing (e.g., those employing a brush which scans along the substrate's surface, those employing rotating roller brushes, etc.) or polishing apparatus (e.g., those employing rotating or translating polishing pads, or those which scan the substrate along a moving or stationary polishing pad), an exemplary scrubber which may employ the inventive scrubber brush is disclosed in U. S. patent application Ser. No. 09/113,447 filed on Jul. 10, 1998 (AMAT No. 2401/CMP/RKK), and an exemplary polishing apparatus which may employ the inventive polishing pad is disclosed in U.S. patent application Ser. No. 09/208,143 filed on Dec. 9, 1998 (AMAT No. 2925/CMP/RKK). Each of the above identified U.S. patent applications is incorporated herein in its entirety by this reference.

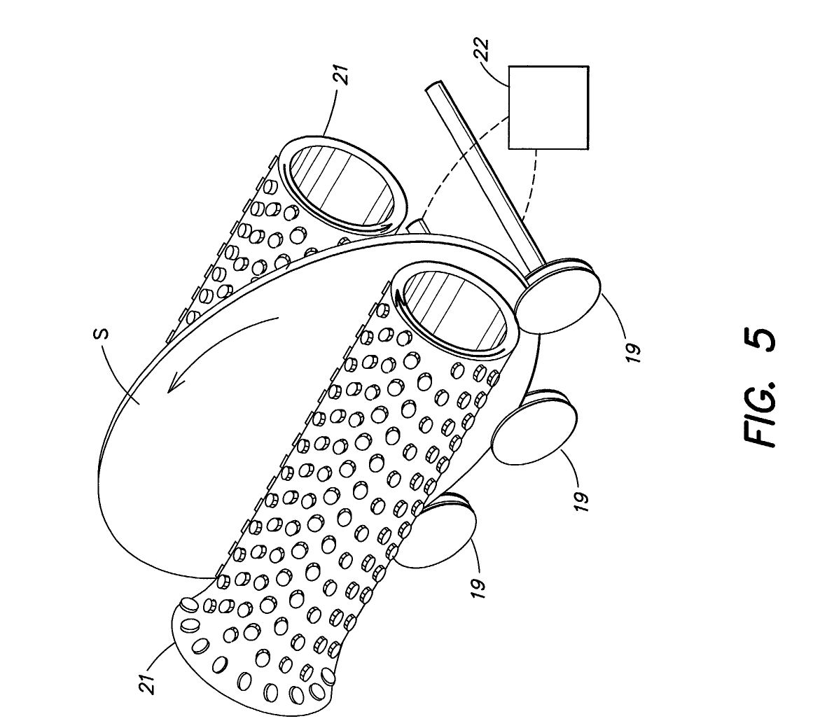

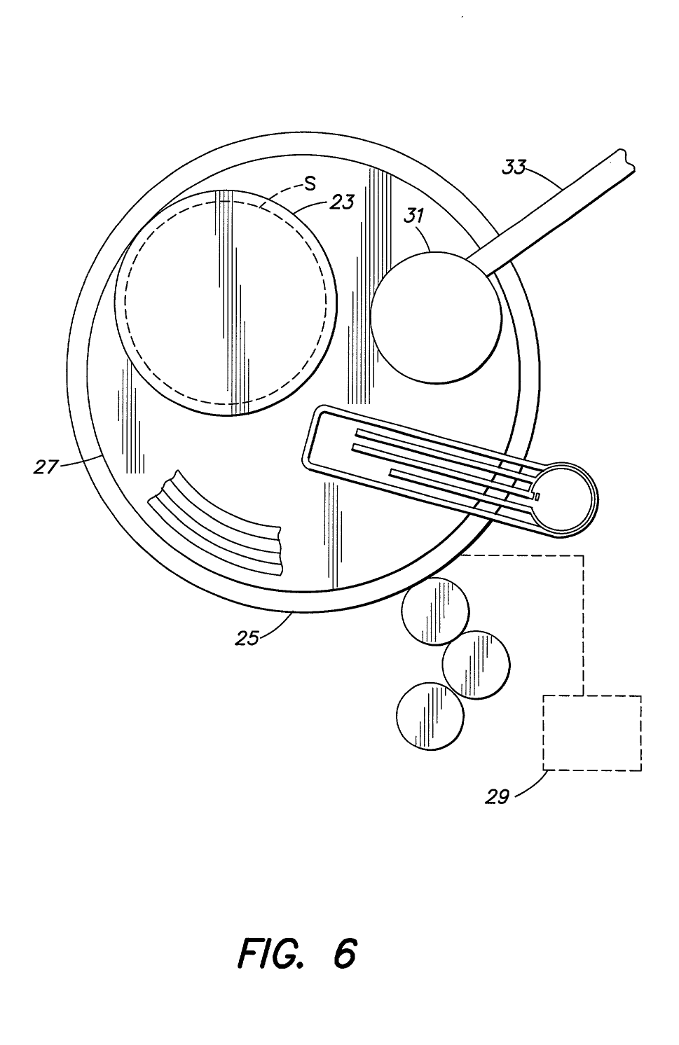

An exemplary scrubber and an exemplary polisher are shown in the side schematic views of FIGS. 5 and 6 respectively. The scrubber of FIG. 5 has a substrate support comprising a plurality of rollers 19 adapted to support a substrate, a roller type scrubber brush 21 adapted to contact a substrate supported by the rollers 19, and a motor 22 coupled to and adapted to rotate the rollers 19 so as to generate relative movement between a substrate supported thereon, and the scrubber brush 21.

The polisher of FIG. 6 has a substrate support comprising a carrier head 23 to which the substrate is attached, a rotatable platen 25 on which a polishing pad 27 is positioned, and a motor 29 adapted to cause the platen 25 to rotate. The polisher also comprises a conditioning head 31 adapted to condition or roughen the polishing pad 27 and a conditioning arm 33 coupled to the conditioning head 31. The conditioning arm 33 is adapted to sweep the conditioning head 31 radially across the surface of the polishing pad 27 while applying a downward force.

The foregoing description discloses only exemplary embodiments of the invention; modifications of the above disclosed apparatus and method which fall within the scope of the invention will be readily apparent to those of ordinary skill in the art. For instance, the inventive polishing pad (e.g., a porous material saturated with the complexing agent so as to form a homogeneous polishing pad) may be conditioned in situ by using the conditioning head 31 (FIG. 6) to remove used complexing agent, which contains metal particles adhered to the surfaces of the inventive polishing pad; thereby a new layer of unused complexing agent is exposed. Because the inventive pad is homogeneous (e.g., comprised of a porous polystyrene bead soaked in amine), the newly exposed layer also contains the amine and may bond to metal particles.

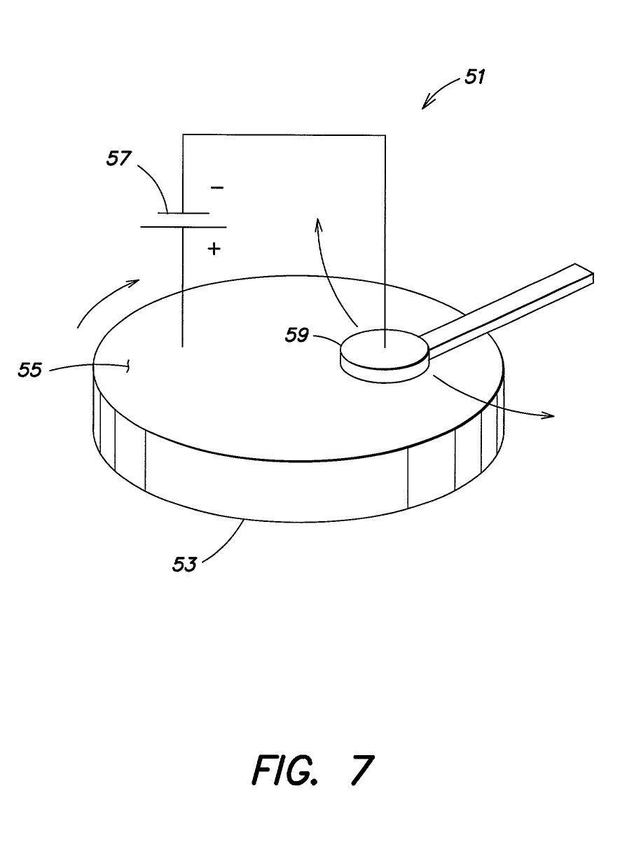

In addition to the above described regeneration processes, an electrochemical regeneration also may be employed. For example, FIG. 7 is a perspective view of a polishing apparatus 51 that employs electrochemical regeneration to regenerate a polishing pad 53. The polishing pad 53 includes a complexing agent as previously described.

With reference to FIG. 7, when the polishing pad 53 becomes loaded with metal ions (e.g., copper ions) or to reduce such loading, the polishing pad 53 may be electrochemically regenerated by (1) applying (via a battery 57) a positive bias to a top surface 55 of the pad 53; and (2) applying (via the battery 57) a negative bias to a metal disk in contact with the pad (such as a conditioning head 59). The metal disk may comprise, for example, copper or any other suitable conductive material. The positive biasing of the pad 53 relative to the metal disk ensures that metal ions (removed from a substrate (not shown) that was or is being polished on the pad 53) are deposited primarily on the metal disk rather than on the pad 53. Saturation of the pad 53 with metal ions thereby is avoided.

Note that the above process may be performed during (e.g., in situ) and/or after (e.g., ex situ) polishing of a substrate on the polishing pad 53. Any suitable metal disk may be employed rather than the conditioning head 59. Also, a similar process may be employed to regenerate a scrubber brush configured in accordance with the present invention. For example, the scrubber brush 10 of FIG. 2 may be regenerated by placing the brush in a metal cylinder (not shown) that contacts the outer surface of the brush, and by biasing the outer surface of the brush positively relative to the metal cylinder.

Accordingly, while the present invention has been disclosed in connection with exemplary embodiments thereof, it should be understood that other embodiments may fall within the spirit and scope of the invention, as defined by the following claims.

The invention claimed is:

1. A method of removing a metal from a substrate comprising:
providing a substrate having metal formed thereon;
contacting the substrate with a reactive surface comprising a first complexing agent; and
removing metal particles from the substrate via bonding between the metal and the first complexing agent.

2. The method of claim 1 wherein providing a substrate comprises providing a semiconductor substrate having a metal formed thereon.

3. The method of claim 1 wherein providing a substrate having a metal formed thereon comprises providing a substrate having a metal compound formed thereon.

4. The method of claim 3 wherein the metal compound comprises a metal oxide.

5. The method of claim 1 further comprising:
cleaning the reactive surface via applying a second complexing agent that is stronger than the first complexing agent to thereby remove metal particles from the reactive surface.

6. The method of claim 5 wherein cleaning the reactive surface via applying a second complexing agent comprises cleaning the reactive surface via applying a second complexing agent comprising ammonium hydroxide, ammonia or carboxylic acid.

7. The method of claim 1 further comprising:
cleaning the reactive surface by electrically biasing the reactive surface.

8. The method of claim 7 wherein electrically biasing the reactive surface comprises:
placing a metal disk on the reactive surface; and
applying a bias between the metal disk and the reactive surface.

9. The method of claim 1 further comprising:
cleaning the reactive surface with sulfuric acid.

10. The method of claim 1 further comprising:
removing a layer of the reactive surface with a conditioning head to thereby remove the layer of the reactive surface and to expose a new layer of reactive surface.

11. The method of claim 1 wherein contacting the substrate with a reactive surface comprising a first complexing agent comprises contacting the substrate with a reactive surface comprising a first complexing agent comprising a bispicolylamine functionality, an amine, a carboxilate, a chloride or a sulfonate.

12. The method of claim 1 wherein the first complexing agent is solid material attached to the reactive surface.

13. The method of claim 12 wherein the complexing agent is attached to the reactive surface by one of bonding, grafting and blending.

14. A brush apparatus comprising:
a scrubber brush having:
a surface adapted to contact a surface of a substrate to be scrubbed; and
a complexing agent coupled to the scrubber brush surface, the complexing agent adapted to bond to metal particles.

15. The apparatus of claim 14 wherein the complexing agent is adapted to bond to a metal compound.

16. The apparatus of claim 15 wherein the metal compound is a metal oxide.

17. The apparatus of claim 14 wherein the complexing agent is a solid material attached to the scrubber brush surface.

18. The apparatus of claim 17 wherein the complexing agent is attached to the scrubber brush surface by one of bonding, grafting and blending.

19. An apparatus comprising:
a scrubber brush comprised of a homogeneous material comprising a complexing agent adapted to bond to metal particles, and having a surface adapted to contact a surface of a substrate to be scrubbed.

20. A scrubber comprising:
a substrate support adapted to support a substrate;
a brush coupled so as to contact a substrate supported by the substrate support, the brush having:
a surface adapted to contact a surface of a substrate to be scrubbed; and
a complexing agent coupled to the scrubber brush surface, the complexing agent adapted to bond to metal particles; and
a mechanism adapted to generate relative movement between the substrate and the brush apparatus.

21. A method of regenerating a scrubber brush, comprising:
providing a scrubber brush having a reactive surface comprising a first complexing agent to which metal particles have bonded; and
cleaning the reactive surface by applying a second complexing agent that is stronger than the first complexing agent to thereby remove at least some of the metal particles from the reactive surface.

22. The method of claim 21 wherein the second complexing agent is ammonium hydroxide, ammonia or carboxylic acid.

23. A method of regenerating a polishing pad, comprising:
providing a polishing pad having a reactive surface comprising a first complexing agent to which metal particles have bonded; and
cleaning the reactive surface by applying a second complexing agent that is stronger than the first complexing agent to thereby remove at least some of the metal particles from the reactive surface.

24. The method of claim 23 wherein the second complexing agent is ammonium hydroxide, ammonia or carboxylic acid.

25. A method of regenerating a polishing pad, comprising:
providing a polishing pad having a reactive surface comprising a complexing agent to which metal particles have bonded; and
removing a layer of the reactive surface with a conditioning head to expose a new layer of reactive surface.

26. A method of regenerating a scrubber brush, comprising:
providing a scrubber brush having a reactive surface comprising a first complexing agent to which metal particles have bonded; and
cleaning the reactive surface by electrically biasing the reactive surface.

27. The method of claim 26 wherein electrically biasing the reactive surface comprises:
placing a conductive material on the reactive surface; and
applying a bias between the conductive material and the reactive surface.

28. A method of regenerating a polishing pad, comprising:
providing a polishing pad having a reactive surface comprising a first complexing agent to which metal particles have bonded; and
cleaning the reactive surface by electrically biasing the reactive surface.

29. The method of claim 28 wherein applying a bias comprises:
placing a conductive material on the reactive surface; and
applying a bias between the conductive material and the reactive surface.

30. The method of claim 29 wherein the conductive material is part of a conditioning head.

31. A method of regenerating a scrubber brush, comprising:
providing a scrubber brush having a reactive surface comprising a first complexing agent to which metal particles have bonded; and
cleaning the reactive surface with a strong acid to thereby remove at least some of the metal particles from the reactive surface.

32. The method of claim 31 wherein the strong acid is sulfuric acid.

33. A method of regenerating a polishing pad, comprising:
providing a polishing pad having a reactive surface comprising a first complexing agent to which metal particles have bonded; and
cleaning the reactive surface with a strong acid to thereby remove at least some of the metal particles from the reactive surface.
